(19) United States
(12) Patent Application Publication
(10) Pub. No.: US 2016/0329704 A1
(43) Pub. Date: Nov. 10, 2016

(54) Coil with Shunt Impedance for Arc Suppression using an Alternating Current Power Source or a Direct Current Power Source

(71) Applicant: John Richard Archer, Spencer, IN (US)

(72) Inventor: John Richard Archer, Spencer, IN (US)

(21) Appl. No.: 15/216,540

(22) Filed: Jul. 21, 2016

Related U.S. Application Data
(63) Continuation-in-part of application No. 14/701,500, filed on Apr. 30, 2015.
(60) Provisional application No. 61/986,315, filed on Apr. 30, 2014.

(51) Int. Cl. H02H 9/08

(52) U.S. Cl. CPC H02H 9/08

(57) ABSTRACT

A device used for preventing arcs and initial power line current increase in an electrical wiring circuit in an electric circuit contains an output source terminal, an input load terminal, a suppressor coil, and a shunt circuit. The output source circuit can be either an alternating power source or a direct current power source. The suppressor coil is electrically connected in between the output power source and the input load terminal. In order to prevent arc formation and shape the current passing through the suppressor coil, the shunt circuit is electrically connected in parallel to the suppressor coil. The shunt circuit includes at least one resistor. The suppressor coil can use either a permeable coil or an air core coil. The design of the device allows a circuit breaker to be used in series without affecting the normal operation. Moreover, the device does not require resetting after use.

The current application is a continuation-in-part (CIP) application of a U.S. non-provisional application Ser. No. 14/701,500 filed on Apr. 30, 2015. The U.S. non-provisional application Ser. No. 14/701,500 claims a priority to a U.S. provisional application Ser. No. 61/986,315 filed on Apr. 30, 2014.

### FIELD OF THE INVENTION

The present invention relates generally to a circuit design that can prevent or reduce the possibility of electrical arcing which can occur through a rapid reduction of voltage across an electrical circuit.

### BACKGROUND OF THE INVENTION

An electrical arc is a visible plasma discharge between two electrodes that is caused by electrical current ionizing gasses in the air. Electrical arcing can lead to local ignition of vapors or flammable items. Therefore, it is clearly evident that a method for effectively suppressing an electrical arc is essential.

Arc suppression can be done through various methods. Metal film deposition and sputtering and arc flash protection equipment are some of the most renowned arc suppression methods. Even though these arc suppressing techniques have a series of advantages, certain disadvantages are also seen. For instance, most arc suppression techniques require a considerable financial investment. Therefore, the additional investment has resulted in using these arc suppression techniques sparingly. Another disadvantage of arc suppression techniques is the inability to be used with every circuit. Certain circuit configurations utilized for arc suppression require current and voltage requirements. As an example, most arc suppression circuits function with only an alternating current power source or with only a direct current power source. Therefore, the number of circuits the arc suppression circuit can be used with is limited.

A series pass transistor can also be used to prevent arc formation. Similar to the present invention, the series pass transistor can reduce or remove voltage from the input load terminal. However, during normal operation the series pass transistor requires a large heat sink.

The objective of the present invention is to address the aforementioned issues and to control any sudden change in the value of the power line current. More specifically, the present invention is intended to prevent damage to electrical wiring and associated components due to an event that could produce arcing at the load end, or along a power line. In doing so, an inductance with a parallel shunt impedance is added to the circuit in between the electrical load and the power source. Moreover, the present invention can be used with both an alternating current source and a direct current power source.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an illustration of the circuit diagram of the present invention.

FIG. 2 is a circuit diagram of the power line.

FIG. 3 is a graph illustrating the simulated 22V fault situation.

FIG. 4 is a graph illustrating the behavior of the unprotected fault current.

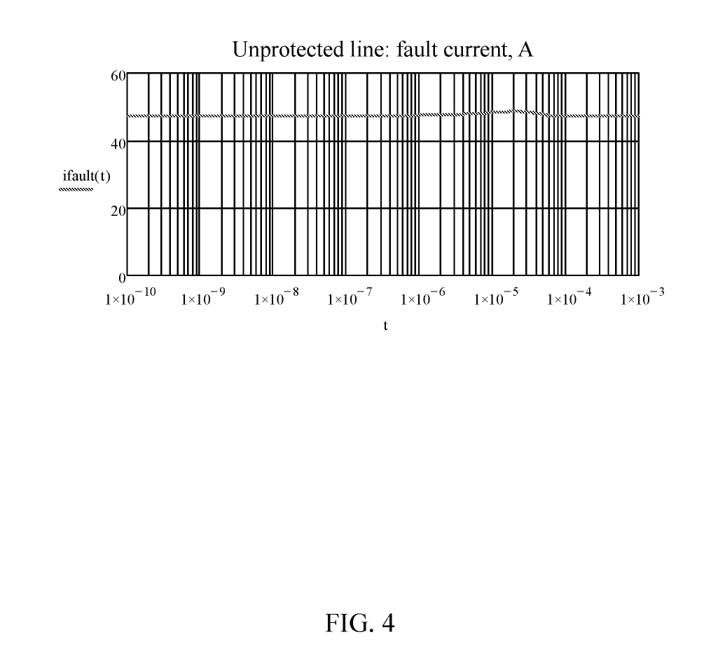

FIG. 5 is a graph illustrating the behavior of the line current.

FIG. 6 is a graph illustrating the protected circuit coil operation.

FIG. 7 is a graph illustrating the voltage across the load.

FIG. 8 is a graph illustrating the energy flow to the load.

FIG. 9 is a graph showing the short-circuit release to a high resistance.

FIG. 10 is a graph illustrating the unprotected line fault current.

FIG. 11 is a graph illustrating the unprotected line fault voltage.

FIG. 12 is a graph illustrating a load fault voltage for a known time.

FIG. 13 is a graph illustrating the modelled strobe light current pulse.

FIG. 14 is a graph illustrating the input impedance.

FIG. 15 is a graph illustrating the unprotected line current.

FIG. 16 is a graph illustrating the unprotected line fault energy.

FIG. 17 is a graph illustrating the temperature behavior.

FIG. 18 is a graph illustrating the protected circuit fault current.

FIG. 19 is a graph illustrating the initial fault coil voltage.

FIG. 20 is a graph illustrating the suppressor coil operation of the present invention.

FIG. 21 is a graph illustrating the line current of the present invention.

FIG. 22 is a graph illustrating the protected line short circuit release current.

FIG. 23 is a graph illustrating the protected line short circuit release voltage.

FIG. 24 is a graph illustrating the protected line input voltage.

FIG. 25 is a graph illustrating the protected line coil voltage.

FIG. 26 is a graph illustrating the protected line short circuit release energy.

FIG. 27 is a graph illustrating the unprotected line short circuit release current.

FIG. 28 is a graph illustrating the unprotected line short circuit release voltage.

FIG. 29 is a graph illustrating the unprotected line short circuit release energy.

### DETAIL DESCRIPTIONS OF THE INVENTION

All illustrations of the drawings are for the purpose of describing selected versions of the present invention and are not intended to limit the scope of the present invention.

The present invention introduces an apparatus that can prevent arc formation in an electrical load fed by an alternating current (AC) power source or a direct current (DC) power source. In other words, the design example and mathematical equations assume that the power source frequency is too low to produce a significant voltage drop across the coil. This leads to the arc suppression time being similar to a DC power source. More specifically, the present invention introduces a method for controlling the onset and release of the effects of a fast acting fault impressed across a supplied electrical load. In doing so, the present invention removes power from the fault location as soon as the necessary requirements for arc formation occurs, so that the chance of fire or Kapton carbon tube formation is lessened. More specifically, with the design of the present invention there is a reduced amount of voltage across the power line feed to the load. Most of the load voltage change appears across the coil immediately due to the line properties and time delay. However, all circuit component voltage drops voltages need to sum up to the supply voltage at any given instant. A suppressor coil and a parallel shunt circuit are added to a circuit in between the power source and the electric load to remove power from the electric load within a short period of time. The levels of load voltage and power calculated without the use of the suppressor circuit can cause significant damage. The preferred embodiment of the present invention is intended to be used in an aircraft circuit. However, the present invention can also be used in any other circuit where an electric arc can occur. By utilizing the present invention, initial fault supply line current surges can be controlled or prevented. Additionally, the present invention eliminates voltage or current transition spikes and also can be designed to control device overheating due to circuit breaker malfunctioning or other series control circuit malfunction. More specifically, the present invention can be designed to survive overheating from circuit breaker malfunctioning or other control malfunctioning. Moreover, the size of the coil will depend on the available short circuit current.

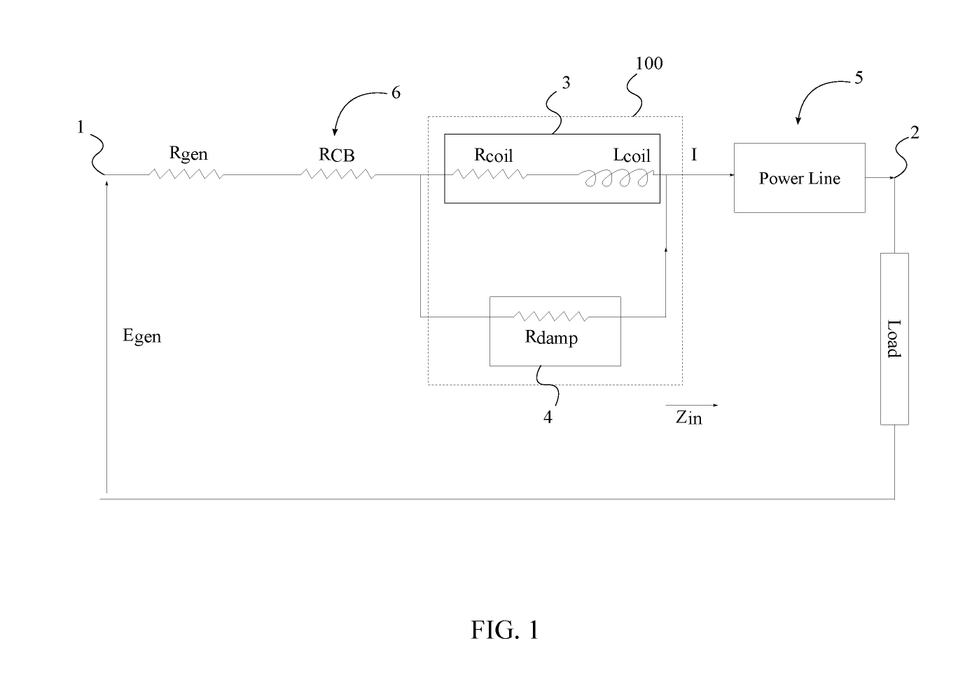

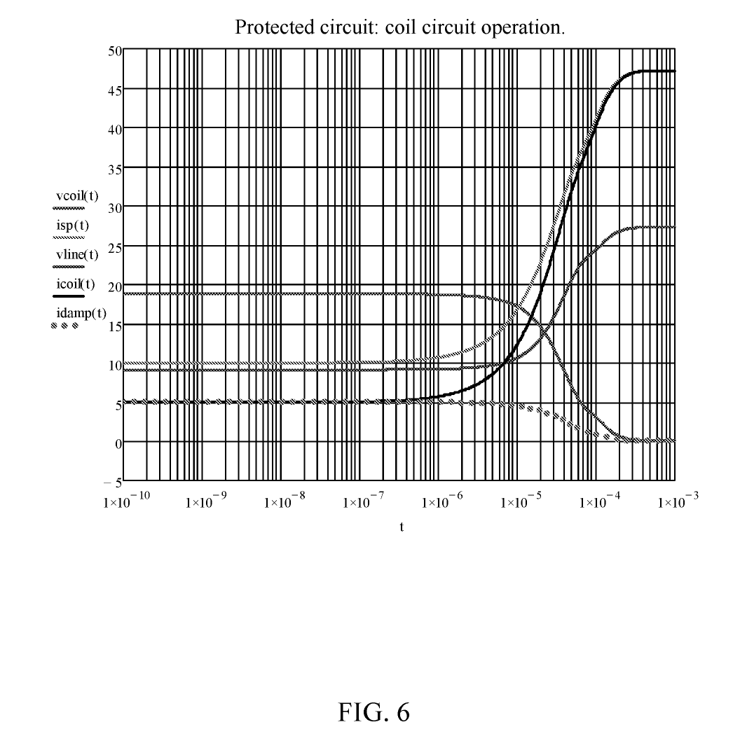

The present invention comprises an output source terminal 1, an input load terminal 2, a suppressor coil 3, and a shunt circuit 4. The suppressor coil 3 can be an air cored coil. However, in other embodiments of the present invention, the suppressor coil 3 can be made of a comparable material with similar magnetic properties. As an example, in another embodiment of the present invention the suppressor coil 3 can comprise a permeable core. In order to remove the initial power surge from the output source terminal 1 and prevent arc formation, the suppressor coil 3 is electrically connected in series between the output source terminal 1 and the input load terminal 2. In other words, the suppressor coil 3 and the shunt circuit 4 delay the buildup of a short circuit current and remove a load power and a load voltage during the time period where an arc could form. The operation of a protected circuit is illustrated in FIG. 6. The suppressor coil 3 is a damped inductance, with circuit values chosen to control the value of the power supply current at the load transition while controlling the fault transition. Therefore, the vector sum of the circuit voltages across the suppressor coil 3, the shunt circuit 4, and the input load terminal 2 is equal to the voltage at the output source terminal 1. In other words, the circuit voltages must sum up to the supply voltage value during the fault transition. The suppressor coil 3 is configured to generate electrical inductance and to be electrically resistive. The inductance and the resistance of the suppressor coil 3 are electrically connected to each other in series. Similar to the suppressor coil 3, the shunt circuit 4 is also electrically connected in series between the output source terminal 1 and the input load terminal 2. However, for the shunt circuit 4 to divert current away from the suppressor coil 3, the suppressor coil 3 and the shunt circuit 4 are connected in parallel to each other such that the shunt circuit 4 creates a low impedance path for the current to flow through. Any component connected in parallel to the suppressor coil 3 is represented by the shunt circuit 4. Diverting current away helps reduce the suppressor coil 3 magnetization. More specifically, the suppressor coil 3 and the shunt circuit 4 act as a temporary virtual series control element with high efficiency preventing local ignition of vapors or flammable items. In other words, when the fault current travels from the output source terminal 1 to the input load terminal 2, the output source terminal 1, the suppressor coil 3, the input load terminal 2, and the shunt circuit 4 are configured to reroute a portion of the fault current from travelling through the suppressor coil 3 to alternatively travelling through the shunt circuit 4. As a result of rerouting a portion of the fault current, the present invention controls the initial rise in the power line current. In other words, the configuration between the output source terminal 1, the suppressor coil 3, the input load terminal 2, and the shunt circuit 4 manages an initial rise in current as a regular current jumps to the fault current. Moreover, the shunt circuit 4 helps in making the suppressor coil 3 small in size with a small permeable core air gap. In general, the shunt circuit 4 controls the suppressor coil 3 current, peak voltage, amplitude of the residual fault current, and the load fault voltage. Moreover, the shunt circuit 4 holds the suppressor coil 3 current and voltage to safe and steady values while reducing the line input current and minimizing the voltage exiting the suppressor coil 3. The shunt circuit 4 comprises at least one resistor. Ideally, a resistive shunt path is needed to allow the DC current flow. Practically, the single resistor may have an at least one inductor connected in series and acts as a fine adjustment of the initial fault power supply current. Component tolerances may prevent a close attainment of the desired initial fault current. The number of turns of a small coil, in series with R_{damp} may be adjusted to better approach the desired current value. Additionally, other active or passive components can be added in parallel as long as the basic DC shunt circuit requirements are satisfied. In general, the shunt circuit 4 is designed to control and shape the suppressor coil 3 current and decrease the suppressor coil 3 magnetization. In other words, the shunt circuit 4 can be a combination of any number of active devices which can be, but is not limited to, resistors, inductors, or capacitors as long as the DC conduction path is satisfied. The combination of the shunt circuit 4 helps reduce the physical size of the suppressor coil 3. As a result, the suppressor coil 3 has low winding power loss, lower inductance, and a reduced voltage drop. The configuration of the shunt circuit 4 can differ according to the circuit the present invention is used in. In reference to FIG. 1, the shunt circuit 4 is represented by R_{damp}. The suppressor coil 3 resistance is represented by R_{coil} and the suppressor coil 3 inductance is represented by L_{Coil}. As seen in FIG. 1, the suppressor coil 3 is in parallel with the shunt circuit 4. In other words, the shunt circuit 4 is a placeholder for a simple or complex impedance. When designing the shunt circuit 4, a specific inductor can be connected in series with an initial shunt resistor of the shunt circuit 4 to adjust the initial supply fault current. Additionally, other circuit components can be connected in parallel with the shunt circuit 4 to achieve different circuit functionalities. However, these other circuit components also need to satisfy circuit design conditions for the shunt circuit 4.

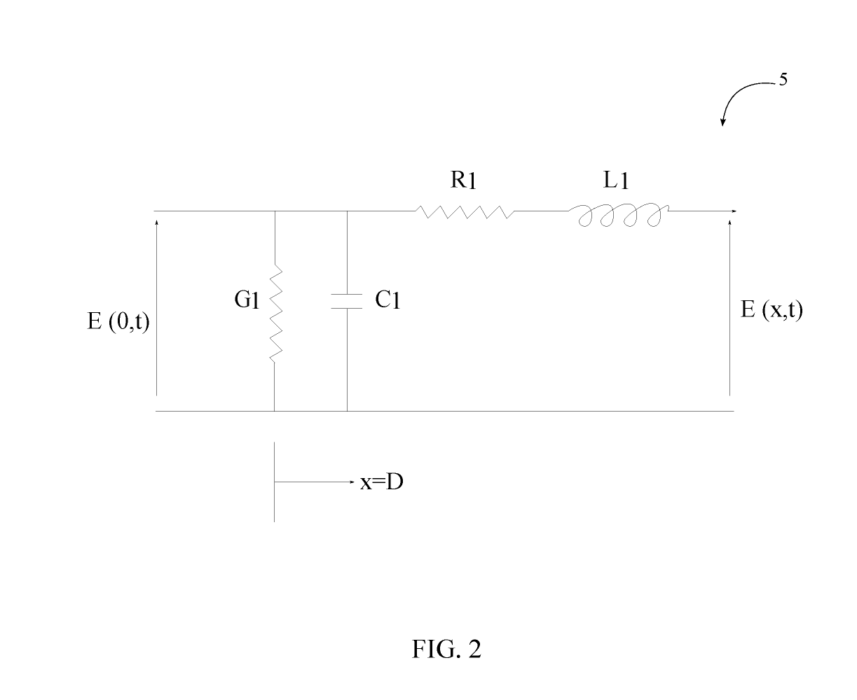

The present invention further comprises an at least one power line 5 that extends from the suppressor coil 3 to the input load terminal 2. In the preferred embodiment of the present invention at least one power line 5 is a wired power line. More specifically, the suppressor coil 3 is electrically connected in series with the input load terminal 2 through the power line 5. Since the shunt circuit 4 is electrically connected between the output source terminal 1 and the input load terminal 2, the shunt circuit 4 is electrically connected in series with the input load terminal 2 through the power line 5. The preferred embodiment of the present invention is intended to be used in an aircraft circuit. Therefore, a portion of the power line 5 can be a portion of the aircraft body. However, in different embodiments of the present invention the portion of the power line can be part of an equipment body or structural body. The power line 5 utilized in the present invention is represented in FIG. 2. More specifically, when the present invention is being used, a two wire power line is utilized so that one line can be a return path through the conducting frame of the equipment and its environment.

The present invention is electrically connected to a circuit breaker 6. As an example, the electrical connection can be connected to another series control device, which is typical usage for suppressor circuit operation but is not essential for suppressor circuit operation. The circuit breaker 6 is electrically connected in series between the output source terminal 1 and the input load terminal 2. Therefore, a resistance of the circuit breaker 6, R_{CB}, is also connected in series between the output source terminal 1 and the input load terminal 2. As discussed earlier, a circuit of the suppressor coil 3 diverts a portion of the current from the suppressor coil 3, such that the current through the circuit breaker 6 reduces to a value less than the normal short circuit value which was initially high. More specifically, the suppressor coil 3 and the shunt circuit 4 hold the fault voltage of the input load terminal 2 below a specific voltage which may lead to arc formation. The voltage is maintained until the arc formation conditions disperse or the circuit breaker 6 is activated. The series connection of the circuit between the output source terminal 1 and the input load terminal 2 allows the circuit breaker 6 to trip if the fault at the input load terminal 2 continues beyond the initial quenching time. In other words, the suppressor coil 3 and the shunt circuit 4 do not interfere with the normal operation of the circuit breaker 6. The circuit breaker 6 current is set from the circuit breaker 6 trip time, power line parameters, and the power source capability. Since the shunt circuit 4 in parallel to the suppressor coil 3 diverts current away from the suppressor coil 3, and the circuit breaker 6 trips after the initial quenching time, the suppressor coil circuit resets automatically. Even though the preferred embodiment of the present invention is electrically connected to the circuit breaker 6, the present invention can also function without the circuit breaker 6. Furthermore, in an alternative embodiment of the present invention, the circuit breaker 6 can be integrated as a component of the present invention.

The effective design of the present invention can prevent arc formation when the output source terminal 1 is for an alternating current (AC) power source and also when the output source terminal 1 is for a direct current (DC) power source. Therefore, the present invention can be used in a wide range of applications.

As mentioned earlier, the suppressor coil 3 and the shunt circuit 4 which are parallel to each other are connected in series with the circuit breaker 6 individually. An enclosure 100 in which the suppressor coil 3 and the shunt circuit 4 are mounted in allows the user to connect the suppressor coil 3 and shunt circuit 4 in series with the circuit breaker 6 conveniently. However, in other embodiments of the present invention the enclosure 100 can be omitted. The output source terminal 1 and the input load terminal 2 are positioned into the enclosure 100 in order to maintain the series connection.

The following section describes the operation of the present invention. In the preferred embodiment of the present invention, the present invention prevents arc formation for an AC input load terminal or a DC input load terminal for the first ten microseconds or more. However, in another embodiment of the present invention, the arc formation can be controlled for different time periods. The normal line leakage currents are considered to be insignificant when compared to the normal current or the fault current. In order to generate a response from the suppressor coil 3 and the shunt circuit 4, the fault transition needs to be fast.

The preferred embodiment of the present invention is designed to be used to prevent aircraft wiring damage or a possible explosive situation. Therefore, the values utilized in calculations are representative of the values seen on an aircraft circuit. In the following example, the power line 5 resistance is calculated for a circuit that operates at 28 volts (V) supply voltage and for a 10 amperes (A) peak AC or DC current. As mentioned before, the 28V can be from an output source terminal 1 which is AC or DC. Moreover, the power line 5 is considered to be 16 American wire gauge (AWG). In order to calculate the maximum length of the power line 5, the power line 5 resistance is initially calculated in the following manner. In general, when the present invention is being used, the unit size depends on the value of the generator voltage and the power line resistance, since the generator voltage and the power line resistance determine the possible short-circuit current. For the following example, environmental temperature and supply voltage variations are not considered and the basic design process is shown.

Rₗᵢₙₑ—Line resistance
V_{supply}—Supply voltage
I_{DC}—Maximum current

### R_{breaker}—Nominal Resistance

V_{load}—Voltage across load

### R_{coil}—Coil Resistance

### R_{contact}—Contact Resistance

In this example, four contacts are used with each contact having a resistance of 4.5 mΩ.

Rₗᵢₙₑ=V_{supply}/I_{DC}−R_{breaker}−(V_{load}/I_{DC})−R_{coil}—(4*R_{contact})

Rₗᵢₙₑ=[(28/10)−0.14−(22/10)−0.00393−0.018]=0.564Ω

Therefore, the maximum length of the power line 5 at a resistance of 0.028 Ω/m is

(0.564/0.028) m=20.14 m

The following values for the suppressor coil 3 are utilized in the upcoming calculations. However, the values can change according to the circuit the present invention is being utilized in. In the following example, the wire or component temperature rise is ignored to simplify the presentation of the design teaching process.
L_{coil}=26.1*10⁻⁶ H
R_{coil}=0.00121 Ω [In this example (0.02*0.32) inch copper tape was used and the coil resistance needs to be minimized.]
C_{Coil}−Winding capacitance of the coil=21*10⁻¹² F
L_{Damp}=1.0*10⁻⁶ H
R_{Damp}—Resistance of the shunt circuit=3.6Ω.
R_{Loss}—The suppressor core-loss effective resistance=109 Ω
The core hysteresis loss is represented as a resistor parallel to the suppressor coil 3. However, the core hysteresis loss is only supplied when the coil voltage is changing.
The following values were used for the power line 5 for the preferred embodiment of the present invention. However, the values can differ in another embodiment of the present invention. As previously calculated, the length of the power line 5 is 20.14 m. However, for calculation purposes the length of the power line 5 is assumed to be 20 m.
L₁—Inductance of the power line=0.682*10⁻⁶ H
C₁—Capacitance of the power line=105. 1*10⁻¹² F

### G₁=0

R₁—Resistance of the power line=0.028 Ω
The values utilized for the input load terminal 2 and the output source terminal 1 are as follows.
E_{gen}—Input load terminal voltage=28V
R_{gen}—Conservative supply impedance=0
R_{CB}—Maximum circuit breaker resistance=0.014 Ω
I₀—The output source terminal current=10 A
R_{contact}—Contact resistance=(4*4.5) mΩ=0.018 Ω
R_{load}—Resistance at the output source terminal=(28/10)−R_{gen}−R_{CB}−D*R₁−R_{contact}=2.203 Ω
C_{load}—Capacitance at the output source terminal=10⁻⁶ F
C_{load} is added to the circuit as an electromagnetic compatibility (EMC) filter. If a direct current power source is applied at the input load terminal 2 voltage, a value such as 2.7Ω+3 μF might be used for C_{load}.

When the present invention is used in the circuit, the voltage across a length of the power line 5 remains approximately steady during the arcing period. Initially, the voltage across the suppressor coil 3 changes from zero and the voltage that is across the power line 5 remains relatively steady such that there is a reduced amount of change in the current in the load power line during the fault quenching time.

The following equations describe the power line:

$$L 1 \cdot ( \frac{d}{d t} i ( x , t ) ) + R 1 \cdot i ( x , t ) = - ( \frac{d}{d x} e ( x , t ) )$$

$$C 1 \cdot ( \frac{d}{d t} e ( x , t ) ) + G 1 \cdot e ( x , t ) = - ( \frac{d}{d x} i ( x , t ) )$$

By executing Laplace operations the following equations are obtained.

$$( s \cdot L 1 + R 1 ) \cdot 1 ( x , s ) = - ( \frac{d}{d x} E ( x , s ) ) + L 1 \cdot i ( x , 0 )$$

$$( s \cdot C 1 + G 1 ) \cdot E ( x , s ) = - ( \frac{d}{d x} I ( x , s ) ) + C 1 \cdot e ( x , 0 )$$

The above formulas are manipulated to the following equations through differentiation and substitution:

$$n ( s ) = \sqrt{( s \cdot L 1 + R 1 ) \cdot ( s \cdot C 1 + G 1 )}$$

$$\frac{{d}^{2}}{d {s}^{2}} I ( x , s ) - {n ( s )}^{2} \cdot I ( x , s ) = C 1 \cdot ( \frac{d}{d x} e ( x , 0 ) ) - L 1 \cdot ( s \cdot C 1 + G 1 ) \cdot i ( x , 0 )$$

$$\frac{{d}^{2}}{d {x}^{2}} E ( x , s ) - {n ( s )}^{2} \cdot E ( x , s ) = L 1 \cdot ( \frac{d}{d x} i ( x , 0 ) ) - C 1 \cdot ( s \cdot L 1 + R 1 ) \cdot e ( x , 0 )$$

The following homogeneous equation was obtained from the calculations above where A1(s) and B1(s) are defined by the external circuit:

Iₕ(x,s)=A1(s)·e^{x·n(s)}+B1(s)·e^{-x·n(s)}=0

The intention of the following analysis is to provide an expression for the non-quiescent loaded line input impedance. When a fault occurs within a circuit, the reduction of the load voltage takes place within a short time period. Resultantly, the lost load voltage is transferred across the remainder of the circuit according to Kirchhoff's second law. Therefore, the circuit can be designed to control the power source current change at the time of the fault.

When the fault occurs, the input voltage from the suppressor coil 3 significantly changes. The present invention provides a virtual, low loss, series control element. Moreover, the present invention can function with a direct current power supply or a relatively slowly varying alternating current power supply. For all conditions, the value of G₁=0. However, with modern wiring insulation materials, line leakage currents are many orders of magnitude less than the currents considered here.

### With G₁=0:

$$n ( s ) = \sqrt{( s \cdot L 1 + R 1 ) \cdot ( s \cdot C 1 )}$$

$$n ( 0 ) = 0$$

$$\frac{{d}^{2}}{d {x}^{2}} I ( x , s ) - {n ( s )}^{2} \cdot C 1 \cdot ( \frac{d}{d x} e ( x , 0 ) ) - L 1 \cdot ( s \cdot C 1 ) \cdot i ( x , 0 )$$

$$\frac{{d}^{2}}{d {x}^{2}} E ( x , s ) - {n ( s )}^{2} \cdot E ( x , s ) = L 1 \cdot ( \frac{d}{d x} i ( x , 0 ) ) - C 1 \cdot ( s \cdot L 1 + R 1 ) \cdot e ( x , 0 )$$

Laplace transform usage for circuits requires a causal response. Non-causal varying response components occurring during calculations are only true at t<0 and are ignored. Negative time is used to determine initial power source data for the particular integral values since the time differential equations are true for all time. At positive time, the dynamic load value is used to set the values of the circuit constants of the homogeneous solutions for the current and the voltage.
For t<0
E(0,s) and I(0,s) are the line inputs for the circuit.
In the circuit used, each end of the line has two contacts, which connect to the power source and the load. The suppressor coil 3 impedance along with R_{CB} form the supply impedance. The formation of a series circuit with one current implies external circuit information in the calculated input impedance equation.
If the line length is D, the line position x has a value of D at the load:

Rload=Zload(0)

Z_{load} does not include two contact resistances.

$$Zgen ( 0 ) = Rcb + Zcoil ( 0 )$$

$$Io = \frac{Egen}{Rload + 4 Rcontact + D \cdot R 1 + Zgen ( 0 )}$$

$$i ( 0 , 0 ) = i ( x , 0 ) = Io$$

$$Eo = Egen - Io \cdot ( Zgen ( 0 ) + 2 \cdot Rcontact )$$

When the voltage drops are summed through the load to the power source

$$e ( x , 0 ) = Io \cdot [ ( D - x ) \cdot R 1 + Rload + 2 Rcontract ]$$

$$\frac{d}{d x} e ( x , 0 ) = - R 1 \cdot Io$$

$$\frac{d}{d x} i ( x , 0 ) = 0$$

Particular integrals are any solutions that fit the differential equations.

$$\frac{{d}^{2}}{d {x}^{2}} I ( x , s ) - ( R 1 + s \cdot L 1 ) \cdot ( s \cdot C 1 ) \cdot I ( x , s ) = C 1 \cdot ( - R 1 \cdot Io ) - L 1 \cdot s \cdot Io$$

$$\frac{{d}^{2}}{d {x}^{2}} E ( x , s ) - ( R 1 + s \cdot L 1 ) \cdot ( s \cdot C 1 ) \cdot E ( x , s ) = - C 1 \cdot ( s \cdot L 1 + R 1 ) \cdot [ Io \cdot ( D - x ) \cdot R 1 + Rload + 2 Rcontract ]$$

When solved the following solutions were obtained:

$$I ( x , s ) = A 1 ( s ) \cdot {e}^{x \cdot n ( s )} + B 1 ( s ) \cdot {e}^{- x \cdot n ( s )} + \frac{Io}{s}$$

$$B ( x , s ) = A 2 ( s ) \cdot {e}^{x \cdot n ( s )} + B 2 ( s ) \cdot {e}^{- x \cdot n ( s )} + \frac{{I}_{o} \cdot [ Rload + 2 \cdot Rcontact + R 1 \cdot ( D - x ) ]}{s}$$

At x=0 and t<0:

$$I ( 0 , s ) = \frac{Io}{s} = A 1 ( s ) + B 1 ( s ) + \frac{Io}{s}$$

$$B 1 ( s ) = - A 1 ( s )$$

$$I ( x , s ) = 2 \cdot A 1 ( s ) \cdot sinh ( x \cdot n ( s ) ) + \frac{Io}{s}$$

$$E ( x , s ) = \frac{- ( \frac{d}{d x} I ( x , s ) ) + C 1 \cdot e ( x , 0 )}{s \cdot C 1}$$

$$E ( x , s ) = \frac{- 2 \cdot n ( s ) \cdot A 1 ( s ) \cdot cosh ( x \cdot n ( s ) )}{s \cdot C 1} + \frac{Io \cdot [ Rload + 2 \cdot Rcontract + R 1 \cdot ( D - x ) ]}{s}$$

$$E ( 0 , s ) = \frac{- 2 \cdot n ( s ) \cdot A 1 ( s )}{s \cdot C 1} + \frac{Io \cdot [ Rload + 2 \cdot Rcontract + R 1 \cdot D ]}{s}$$

$$I ( 0 , s ) = \frac{Io}{s}$$

$$Zin ( s ) = \frac{E ( 0 , s )}{I ( 0 , s )}$$

The value of A₁(s) is calculated for all load conditions t>0
For t>0 at x=D:

$$\frac{I ( D , s ) \cdot ( Zload ( s ) + 2 Rcontact )}{E ( D , s )} = 1$$

$$A 1 ( s ) = \frac{C 1 \cdot Egen \cdot ( Rload - Zload ( s ) )}{[ \begin{matrix}2 \cdot n ( s ) \cdot cosh ( D \cdot n ( s ) ) + \\ ( 2 \cdot C 1 \cdot s \cdot Zload ( s ) + 4 \cdot s \cdot C 1 \cdot Rcontact \cdot s ) \cdot sinh ( D \cdot n ( s ) ) … + \\ Rload + 4 \cdot Rcontact + Zgen ( 0 ) + DR 1\end{matrix} ]}$$

$$Zin ( s ) = \frac{E ( 0 , s )}{I ( 0 , s )} = \frac{\frac{- 2 \cdot n ( s ) \cdot A 1 ( s )}{s \cdot C 1} + \frac{Io \cdot ( Rload + 2 \cdot Rcontact + R 1 \cdot D )}{s}}{\frac{Io}{s}}$$

$$Zin ( s ) = \frac{\frac{\begin{matrix}( Rload + 2 \cdot Rcontact + D \cdot R 1 ) \cdot \\ ( Rload + 4 \cdot Rcontact + Zgen ( s ) + D \cdot R 1 )\end{matrix}}{\begin{matrix}Rload + 4 Rcontact + D \cdot R 1 + Zgen ( 0 ) - \\ ( Rload - Zload ( s ) ) \cdot ( Rload + 4 \cdot Rcontact + Zgen ( s ) + D \cdot R 1 )\end{matrix}} …}{\begin{matrix}[ cosh ( D \cdot n ( s ) ) + \frac{C 1 \cdot s}{n ( s )} \cdot ( Zload ( s ) + 2 \cdot Rcontact ) \cdot sinh ( D \cdot n ( s ) ) ] \cdot \\ ( \begin{matrix}Rload … + \\ 4 \cdot Rcontact … + \\ Zgen ( 0 ) + D \cdot R 1\end{matrix} )\end{matrix}}$$

When s=0 a load short circuit occurs.
R_{load}=Z_{load}=0
Z_{gen} (s)=Z_{gen} (0)
Zen (0)=2*R_{contact} D*R₁; wherein the wiring temperature is ignored.

The distance required for an arc to occur is calculated in the following manner. In this preferred example, the distance required for an arc to occur between two copper electrodes is calculated. For two copper electrodes, the threshold voltage that needs to be overcome is 14.7V since a silicone diode typically has a built-in voltage of 0.7V. The following formula is used in calculating the arcing gap.

V_{arc}=A+M*s*I⁻ⁿ
V_{arc}—Initial breakdown voltage

### A —V_{cathode}

M—Arc vapor constant
T—Anode boiling temperature
n=2.62*T*10⁻⁴ (n=0.67 for copper)
I=arc current
In the preferred example:

### V_{arc}=14.76

### A=14.7V

M=257.6 for copper in air
T=2560K for copper
n=0.67 for copper
Using the above formula for an initial breakdown of 50V/mil, s=0.001*(22/50)=0.0011 inches. Therefore, if the two conductors are 0.0011 inches apart an electric arc is possible.
Furthermore, for the arc gap of 0.0011 inches if the arc current I=10 A,
V_{arc}=A+M*s*I⁻ⁿ
V_{arc}=14.7+256.7*0.0011*10⁻⁰⁶⁷

### V_{arc}=14.7+0.06=14.76V

### R_{arc}=(0.06)/10=0.006 Ω

If the arc current is I=47 A:
V_{arc}=A+M*s*I⁻ⁿ
V_{arc}=14.7+256.7*0.0011*47^{-0.67}

### V_{arc}=14.7+0.021=14.721V

### R_{arc}=(0.021)/47=0.0045 Ω

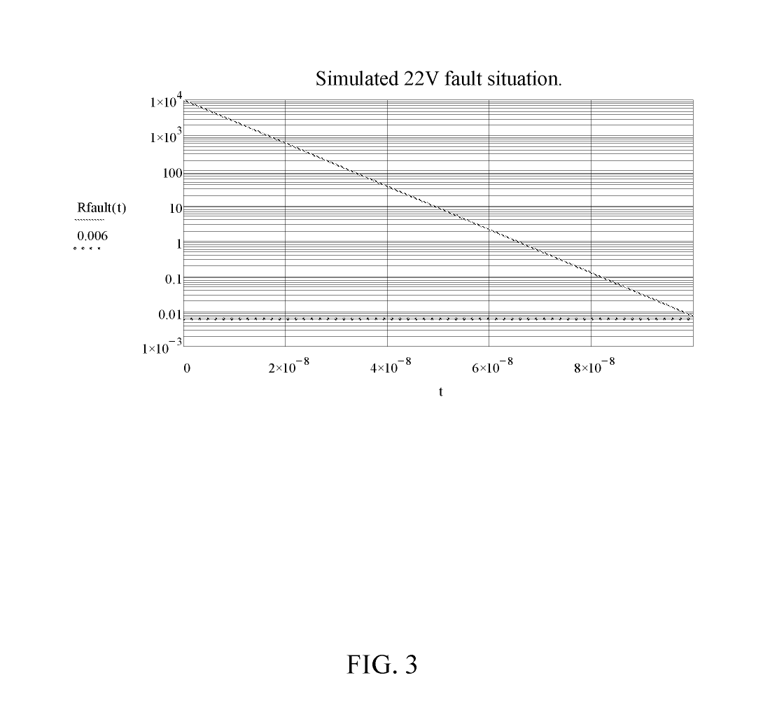

In the preferred example, the possible arc resistance is held for approximately 10 μs followed by a short circuit. However, in different situations the arc resistance can hold for different time periods. The 10 μs allows for shorting time or arcing time and ionization time, after a certain ionizing time. In an unprotected circuit, the worst fault power may occur as the short circuit is released at high current. As seen in FIG. 3, a value of 6 mΩ lasting until 10⁻⁵ s represents the arcing period. The first portion, wherein the resistance drops from infinity to 6 mΩ represents the ionization time which occurs prior to an arc.

The following equations correspond to the simulated 22V load fault situation illustrated in FIG. 3.

$$\underline{Rfault} ( s ) := Rfault ( t ) laplace , t \to \frac{10000.0}{s + 1.4125375446227543022 e 8}$$

$$Zcoil ( s ) := {( \frac{1}{Rcoil + s \cdot Lcoil} + \frac{1}{Rdamp} + \frac{1}{Rloss} + s \cdot Ccoil )}^{- 1}$$

$$n ( s ) := \sqrt{s \cdot C 1 \cdot ( R 1 + s \cdot L 1 )}$$

$$Zgen ( s ) := Rcb + Zcoil ( s )$$

$$Zload ( s ) := {( \frac{1}{Rfault ( s )} + \frac{1}{Rload} + s \cdot Cload )}^{- 1}$$

The generator impedance is conservatively that of the circuit breaker, R_{CB}, which simplifies the equation.

$$Zin ( s ) = \frac{\frac{\begin{matrix}( Rload + 2 \cdot Rcontact + D \cdot R 1 ) \cdot \\ ( Rload + 4 \cdot Rcontact + Zgen ( s ) + D \cdot R 1 )\end{matrix}}{\begin{matrix}Rload + 4 Rcontact + D \cdot R 1 + Zgen ( 0 ) - \\ ( Rload - Zload ( s ) ) \cdot ( Rload + 4 \cdot Rcontact + Zgen ( s ) + D \cdot R 1 )\end{matrix}} …}{\begin{matrix}[ cosh ( D \cdot n ( s ) ) + \frac{C 1 \cdot s}{n ( s )} \cdot ( Zload ( s ) + 2 \cdot Rcontact ) \cdot sinh ( D \cdot n ( s ) ) ] \cdot \\ ( \begin{matrix}Rload … + \\ 4 \cdot Rcontact … + \\ Zgen ( 0 ) + D \cdot R 1\end{matrix} )\end{matrix}}$$

$$\underline{Zload} ( s ) := {( \frac{1}{Rfault ( s )} + \frac{1}{Rload} + s \cdot Cload )}^{- 1}$$

$$Zin ( s ) := ( Rload + 2 \cdot Rcontact + D \cdot R 1 ) … + \frac{- ( Rload - Zload ( s ) )}{[ cosh ( D \cdot n ( s ) ) + \frac{C 1 \cdot s}{n ( s )} \cdot ( Zload ( s ) + 2 \cdot Rcontact ) \cdot sinh ( D \cdot n ( s ) ) ]}$$

$$Iraw ( s ) = \frac{\frac{Egen}{s} + Io \cdot D \cdot L 1}{Rcb + 2 Rcontact + Zin ( s )} \to$$

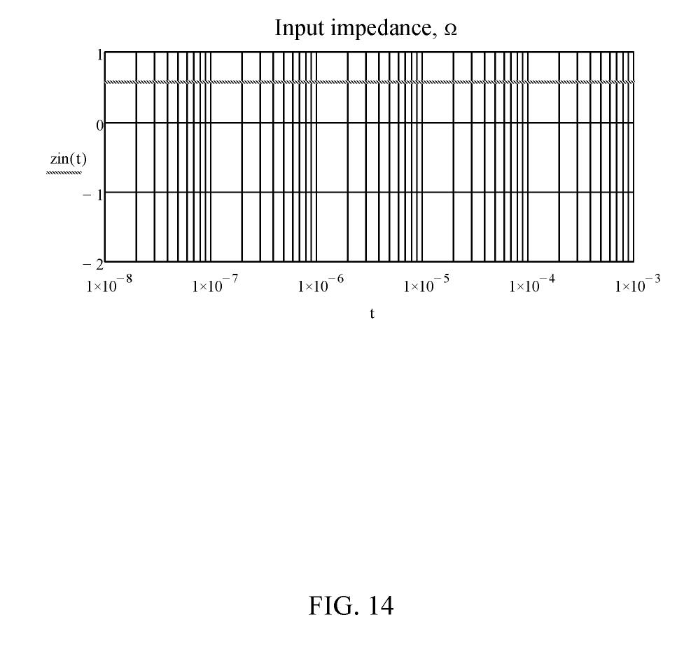

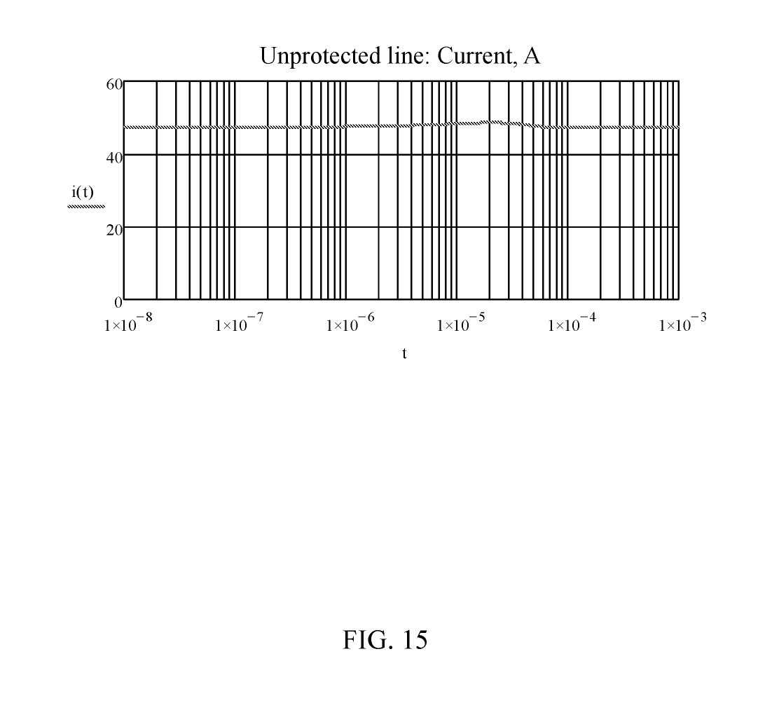

The input impedance and the unprotected line current are illustrated in FIG. 14 and FIG. 15 respectively.
The fault current and voltage are given by the following equations:

$$VF ( s ) = Iraw ( s ) \cdot Zload ( s )$$

$$IF ( s ) = \frac{VF ( s )}{Rfault ( s )}$$

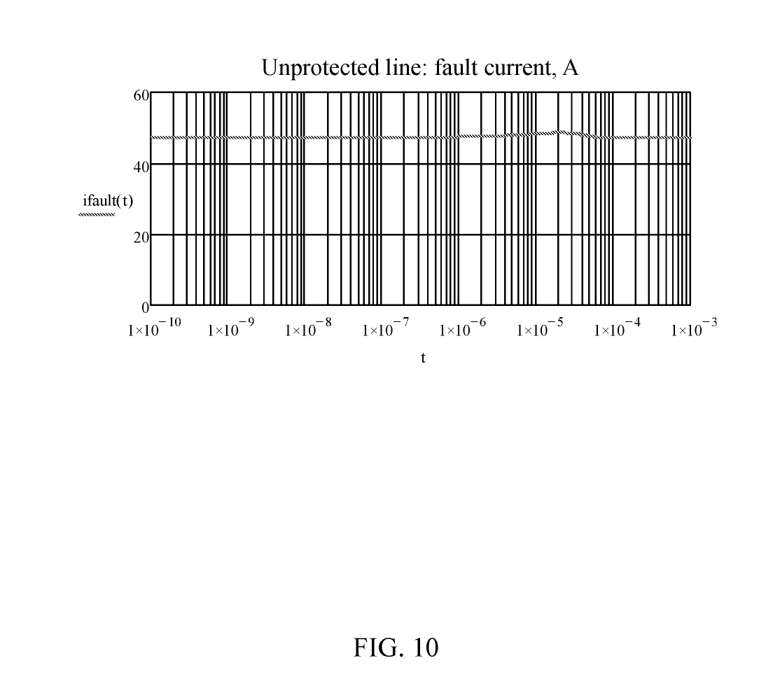

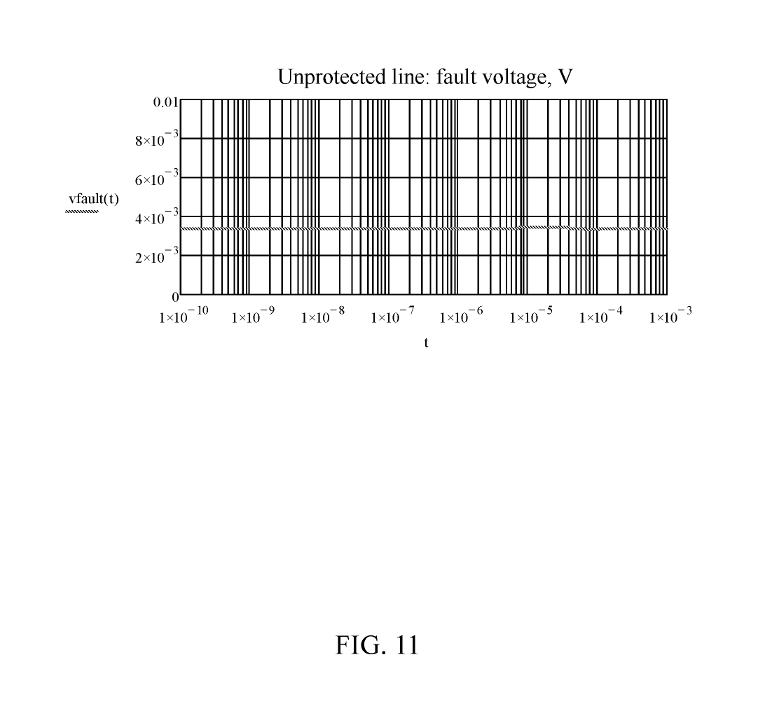

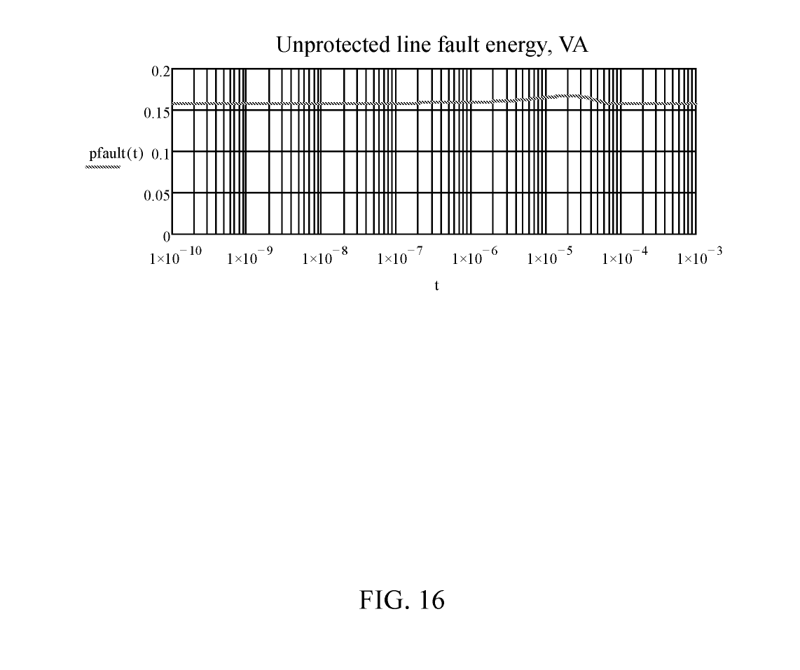

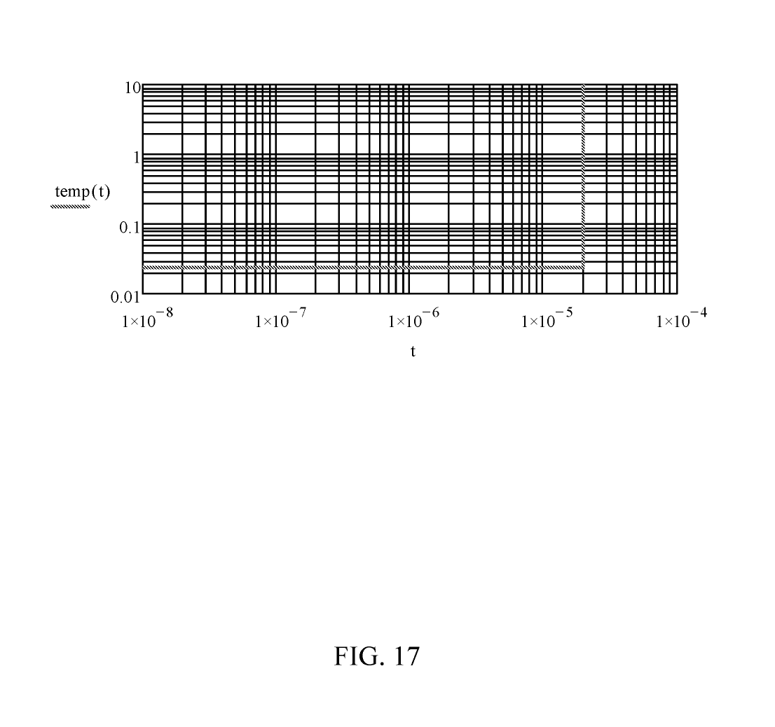

As illustrated in FIG. 10 and FIG. 11, when considering a 20-microsecond fault event idealized as a 24 mΩ fault the following equations are obtained. FIG. 16 and FIG. 17 also illustrate the model behavior for a 20 μs fault.

$$temp ( t ) := 0.024 + {10}^{7} \cdot Φ ( t - 20 \cdot {10}^{- 6} )$$

$$\underline{temp} ( s ) := temp ( t ) laplace , \\ t -> \frac{0.008 \cdot ( 1.25 e 9 \cdot {e}^{- 0.00002 \cdot s} + 3.0 )}{s}$$

$$tempZload ( s ) := {( \frac{1}{Rload} + \frac{1}{temp ( s )} + s \cdot Cload )}^{- 1}$$

$$Zin ( s ) = \frac{\begin{matrix}( Rload + 2 \cdot Rcontact + D \cdot R 1 ) \cdot \\ ( Rload + 4 \cdot Rcontact + Zgen ( s ) + D \cdot R 1 )\end{matrix}}{Rload + 4 Rcontact + D \cdot R 1 + Zgen ( 0 )} … + \frac{\begin{matrix}- ( Rload - tempZload ( s ) ) \cdot \\ ( Rload + 4 \cdot Rcontact + Zgen ( s ) + D \cdot R 1 )\end{matrix}}{\begin{matrix}[ cosh ( D \cdot n ( s ) ) + \frac{C 1 \cdot s}{n ( s )} \cdot ( tempZload ( s ) + 2 \cdot R contact ) \cdot sinh ( D \cdot n ( s ) ) ] \cdot \\ ( \begin{matrix}Rload … + \\ 4 \cdot Rcontact … + \\ Zgen ( 0 ) … + \\ D \cdot R 1\end{matrix} )\end{matrix}}$$

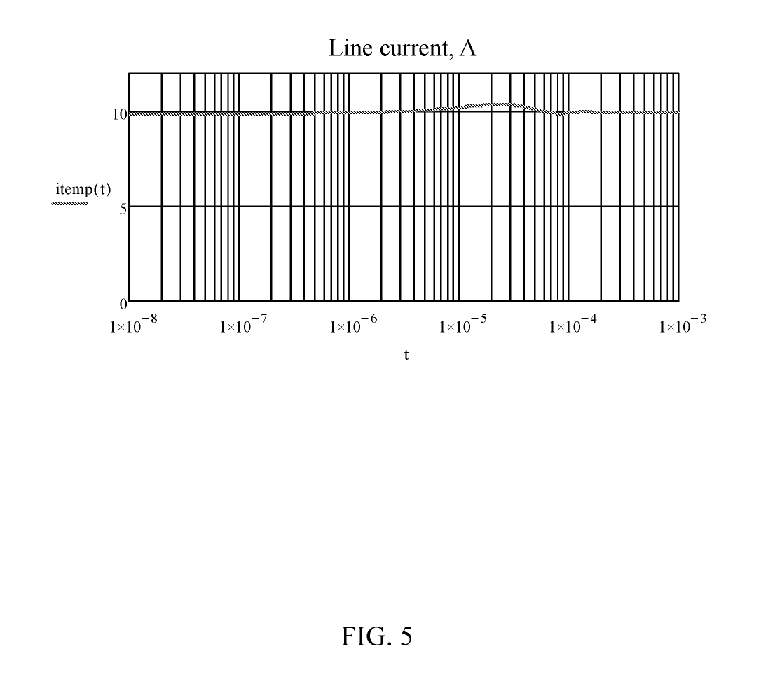

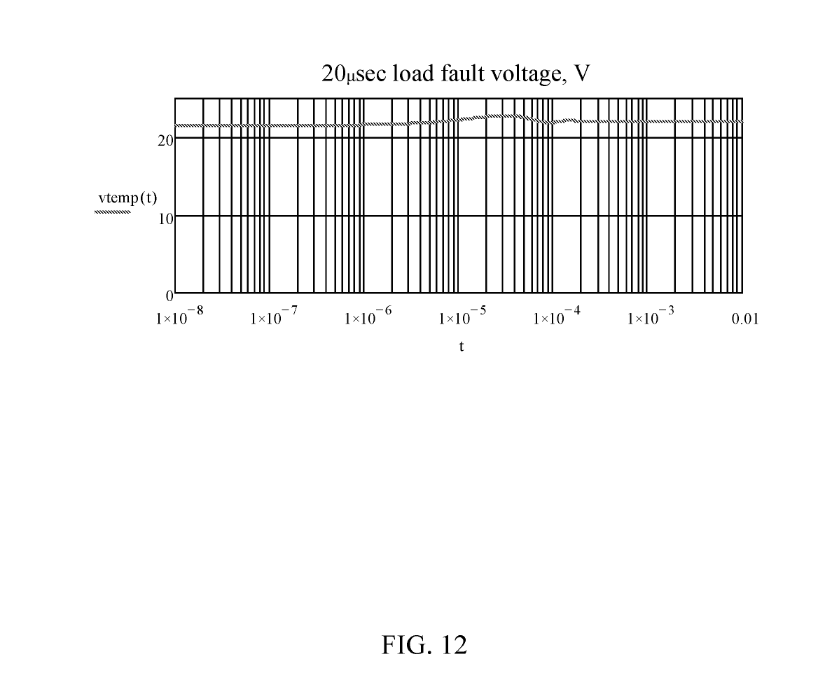

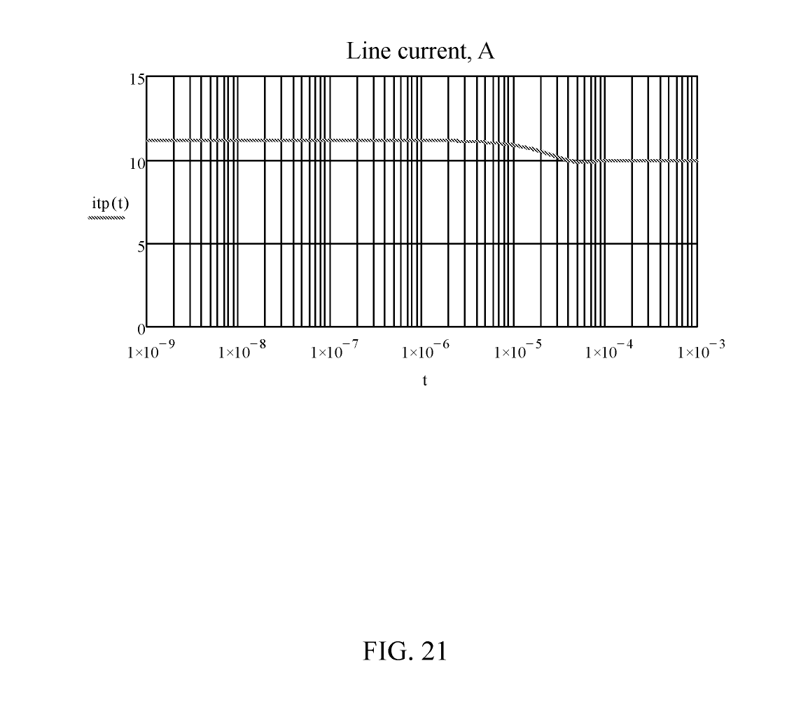

The 20 μs load fault voltage is illustrated in FIG. 12. Moreover, the line current during this time period is illustrated in FIG. 5.
The line current, A, is illustrated in FIG. 21.
For the power line with the suppressor coil circuit:

$$\underline{Zload} ( s ) := {( \frac{1}{Rfault} + \frac{1}{Rload} + s \cdot Cload )}^{- 1}$$

$$\underline{Zin} ( s ) = \frac{\begin{matrix}( Rload + 2 \cdot Rcontact + D \cdot R 1 ) \cdot \\ ( Rload + 4 \cdot Rcontact + Zgen ( s ) + D \cdot R 1 )\end{matrix}}{Rload + 4 Rcontact + D \cdot R 1 + Zgen ( 0 )} … + \frac{- [ \begin{matrix}( Rload - Zload ( s ) ) \cdot \\ ( Rload + 4 \cdot Rcontact + Zgen ( s ) + D \cdot R 1 )\end{matrix} ]}{\begin{matrix}[ cosh ( D \cdot n ( s ) ) + \frac{C 1 \cdot s}{n ( s )} \cdot ( Zload ( s ) + 2 \cdot R contact ) \cdot sinh ( D \cdot n ( s ) ) ] \cdot \\ ( \begin{matrix}Rload … + \\ 4 \cdot Rcontact … + \\ Zgen ( 0 ) + D \cdot R 1\end{matrix} )\end{matrix}}$$

$$Isup ( s ) = \frac{\frac{Egen}{s} + Io \cdot ( Lcoil + D \cdot L 1 )}{Rcb + 2 Rcontact + Zin ( s ) + Zcoil ( s )}$$

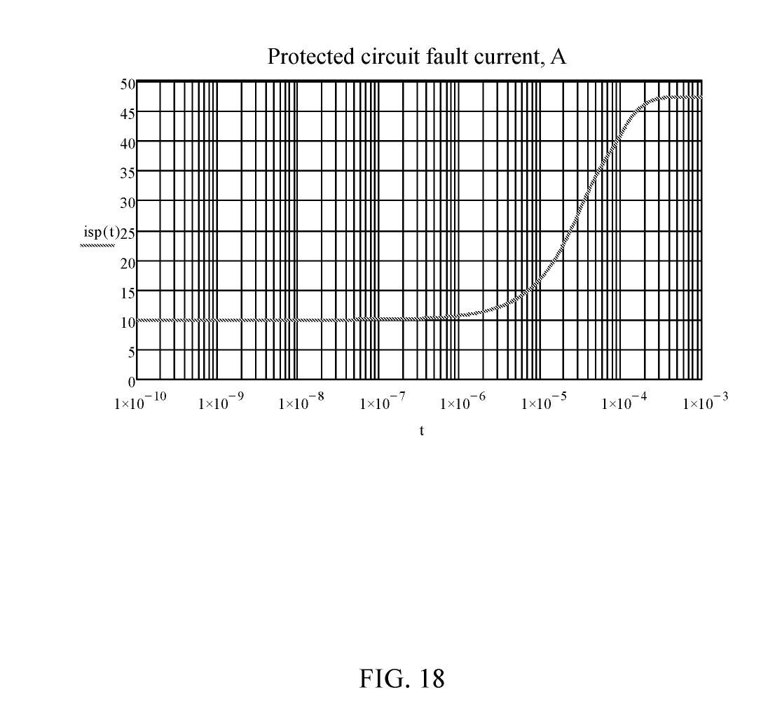

The protected circuit fault current is shown in FIG. 18 and the following equations are used when determining the coil current:

$$Icoil ( s ) = \frac{Isup ( s )}{1 + ( Rcoil + s \cdot Lcoil ) \cdot ( \frac{1}{Rloss} + \frac{1}{Rdamp} + s \cdot Coil )}$$

$${I}_{coil} ( 0 ) = 4.956 A$$

$${I}_{Damp} ( t ) = {I}_{sup} ( t ) - {I}_{coil} ( t )$$

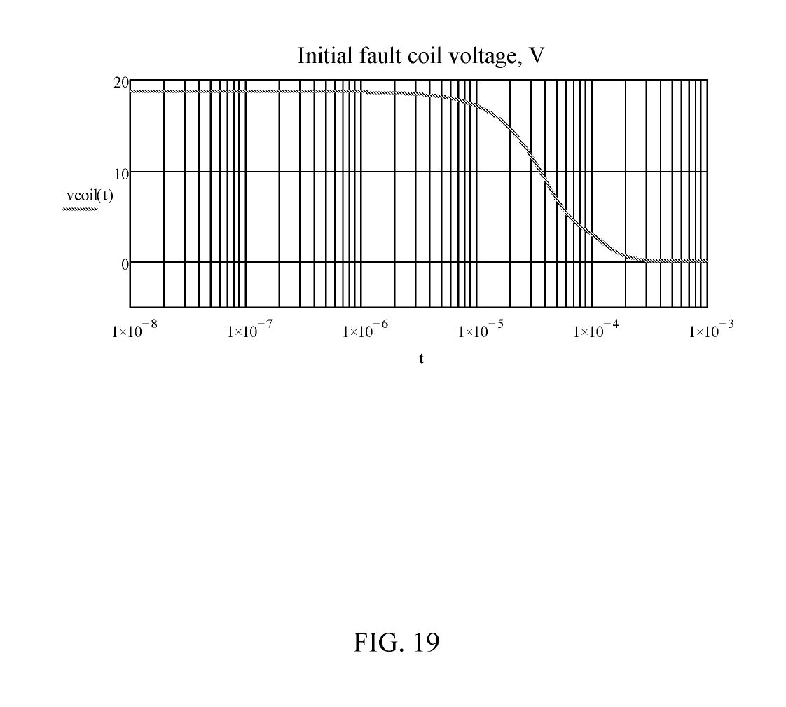

The suppressor coil voltage is given by the following equations and is illustrated in FIG. 19:

V_{coil}(s)=Iₛᵤₚ(s)*Z_{coil}(s)

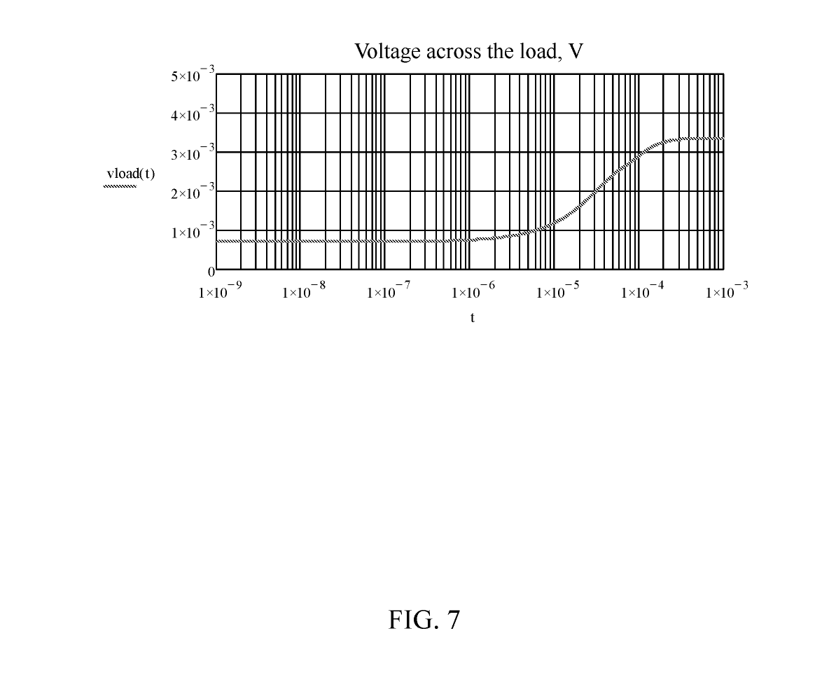

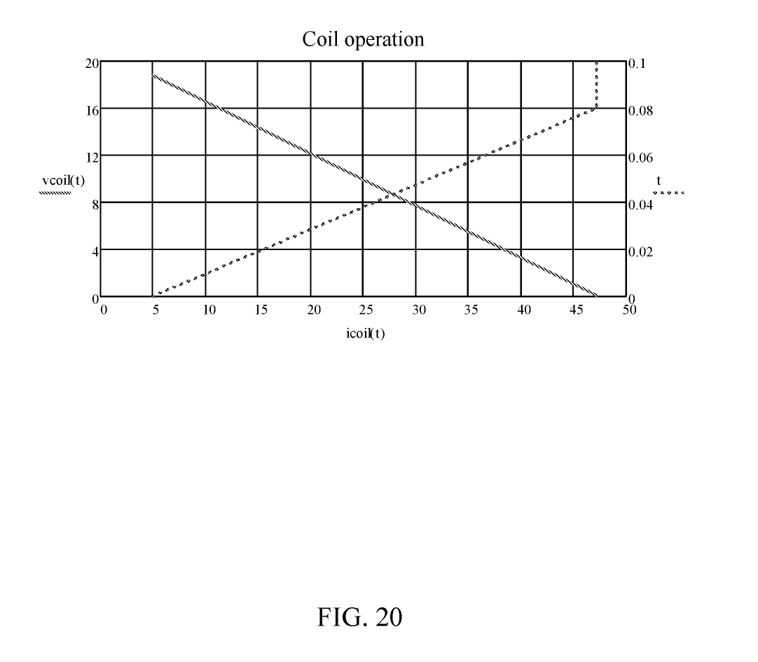

icoil(0)=4.956
icoil(10⁻⁵)=12.295
isp(10⁻⁵)=16.78
isp(0)=9.986
vcoil(0)=18.753
isp(1)=47.195
vline(t):=Egen−isp(t)·Rcb−vcoil(t)
vline(0)=9.107
vlube(0)+vcoil(0)=27.86
The operation of the suppressor coil 3 when in use is illustrated in FIG. 20.
The load voltage is given by the following equation and is illustrated in FIG. 7.

$$vload ( t ) := isp ( t ) \cdot Rfault ( t )$$

$$iFault ( t ) := \frac{vload ( t )}{Rfault ( t )}$$

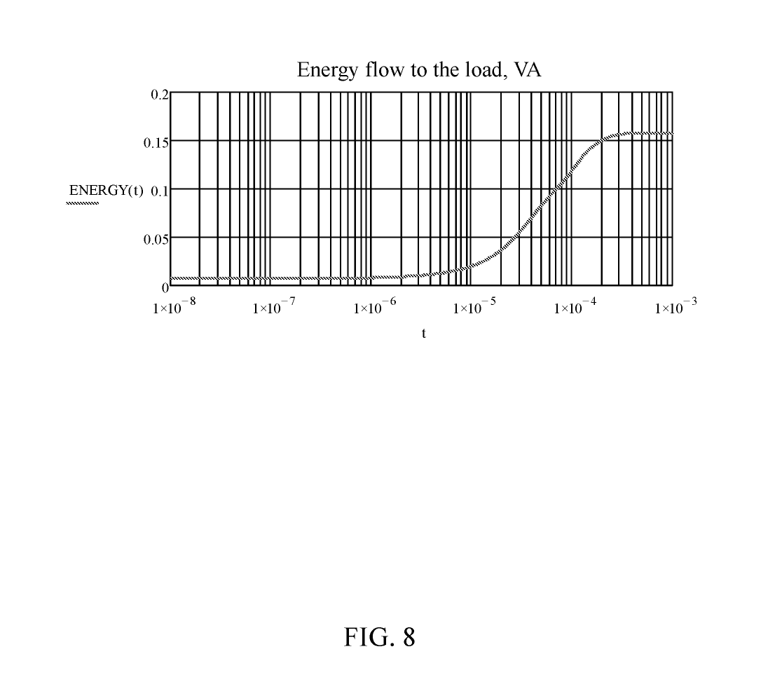

The energy flow to the load is given by the following equation and is illustrated in FIG. 8.

ENERGY(t):=vload(t)·iFault(t)

ENERGY(0)=7.06×10⁻³

The following equations are obtained for a 20 μs fault:

$$\underline{temp} ( t ) := 0.024 + {10}^{7} \cdot Φ ( t - 20 \cdot {10}^{- 6} )$$

$$\underline{temp} ( s ) := temp ( t ) laplace , \\ t -> \frac{0.008 \cdot ( 1.25 e 9 \cdot {e}^{- 0.00002 \cdot s} + 3.0 )}{s}$$

$$tempZload ( s ) = {( \frac{1}{Rload} + \frac{1}{temp ( s )} + s \cdot Cload )}^{- 1}$$

$$Zin ( s ) = \frac{\begin{matrix}( Rload + 2 \cdot Rcontact + D \cdot R 1 ) \cdot \\ ( Rload + 4 \cdot Rcontact + Zgen ( s ) + D \cdot R 1 )\end{matrix}}{Rload + 4 Rcontact + D \cdot R 1 + Zgen ( 0 )} … + \frac{\begin{matrix}- ( Rload - tempZload ( s ) ) \cdot \\ ( Rload + 4 \cdot Rcontact + Zgen ( s ) + D \cdot R 1 )\end{matrix}}{\begin{matrix}[ cosh ( D \cdot n ( s ) ) + \frac{C 1 \cdot s}{n ( s )} \cdot ( tempZload ( s ) + 2 \cdot R contact ) \cdot sinh ( D \cdot n ( s ) ) ] \cdot \\ ( \begin{matrix}Rload … + \\ Zgen ( 0 ) … + \\ D \cdot R 1 … + \\ 4 \cdot Rcontact\end{matrix} )\end{matrix}}$$

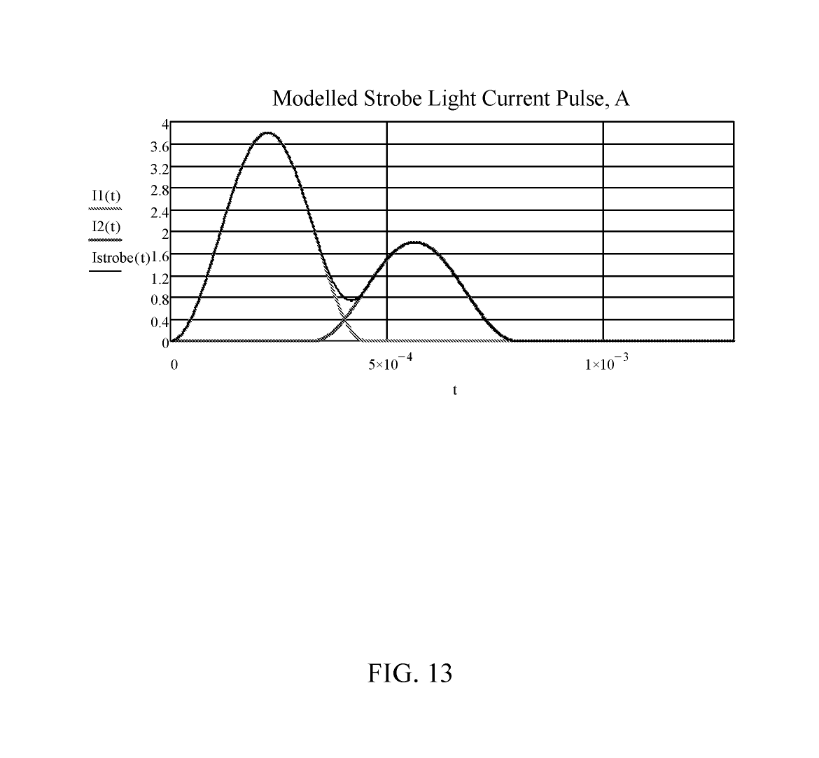

When the present invention is used to model a strobe light action, the following equations are obtained for the sum of two strobe lights. The results obtained are illustrated in FIG. 13.

$$\underline{I 1} ( t ) := 3.8 \cdot {sin ( 2 \cdot π \cdot 1155 \cdot 965 \cdot t )}^{2} \cdot Φ ( 4.5 \cdot {10}^{- 4} - t )$$

$$I 2 ( t ) := [ \begin{matrix}\begin{matrix}1.8 \cdot {sin ( 2 π \cdot 1028 \cdot 1.035 \cdot t + 0.3 \cdot π )}^{2} \cdot \\ Φ ( t - 3.29 \cdot {10}^{- 4} ) … +\end{matrix} \\ - ( \begin{matrix}1.8 \cdot {sin ( 2 π \cdot 1028 \cdot 1.035 \cdot t + 0.3 \cdot π )}^{2} \cdot \\ Φ ( t - {8.10}^{- 4} )\end{matrix} )\end{matrix} ]$$

$$Istrobe ( t ) := [ \begin{matrix}3.8 \cdot {sin ( 2 \cdot π \cdot 1155 \cdot 965 \cdot t )}^{2} \cdot \\ Φ ( 4.5 \cdot {10}^{- 4} - t ) … + \\ ( \begin{matrix}1.8 \cdot {sin ( 2 π \cdot 1028 \cdot 1.035 \cdot t + 0.3 \cdot π )}^{2} \cdot \\ Φ ( t - 3.29 \cdot {10}^{- 4} )\end{matrix} ) … + \\ - ( \begin{matrix}1.8 \cdot {sin ( 2 π \cdot 1028 \cdot 1.035 \cdot t + 0.3 \cdot π )}^{2} \cdot \\ Φ ( t - {8.10}^{- 4} )\end{matrix} ) \end{matrix} ]$$

$$\underline{vstr} ( t ) := ( \begin{matrix}- 1.538 e - 40 \cdot {e}^{- 0.1575 \cdot t} + - 5.48 e - \\ 36 \cdot cos ( 1.176 e - 20 \cdot t ) \cdot {e}^{- 2.063 e - 20 \cdot t} ... + \\ - 9.602 e - 36 \cdot sin ( 1.176 e - 20 \cdot t ) \cdot {e}^{- 2.063 e - 20 \cdot t}\end{matrix} )$$

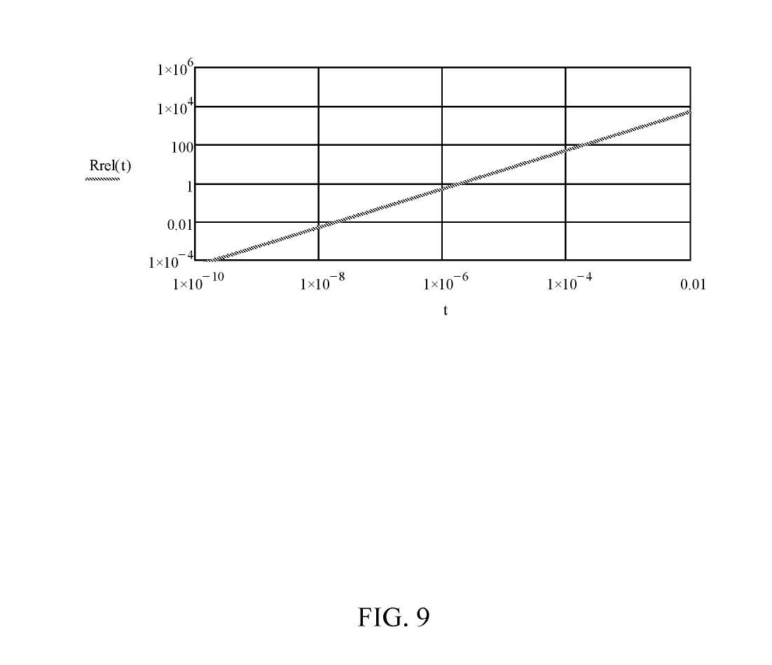

As seen, the voltage of the suppressor coil 3 due to the strobe light is insignificant.
When considering the short circuit release to a high resistance the following equations are obtained along with the results illustrated in FIG. 9.

$$\underline{Rrel} ( s ) := Rrel ( t ) \vert \begin{matrix}laplace , t \\ float , 4\end{matrix} -> \frac{1.0 e 7}{s \cdot ( 20.0 \cdot s + 1.0 )}$$

$$Lsat := 22.88 \cdot {10}^{- 6}$$

$$Zcoilsat ( s ) := {( \frac{1}{Rcoil + s \cdot Lsat} + \frac{1}{Rdamp} + \frac{1}{Rfloss} + s \cdot Ccoil )}^{- 1}$$

$$Zgen 2 ( s ) := Rcb + Zcoilsat ( s )$$

$$Zin ( s ) = 2 \cdot Rcontact + D \cdot R 1 + \frac{ZLoad ( s )}{[ \begin{matrix}cosh ( D \cdot n ( s ) ) + \frac{C 1 \cdot s}{n ( s )} \cdot \\ \begin{matrix}sinh ( D \cdot n ( s ) ) \cdot \\ ( 2 \cdot Rcontact + ZLoad ( s ) )\end{matrix}\end{matrix} ]}$$

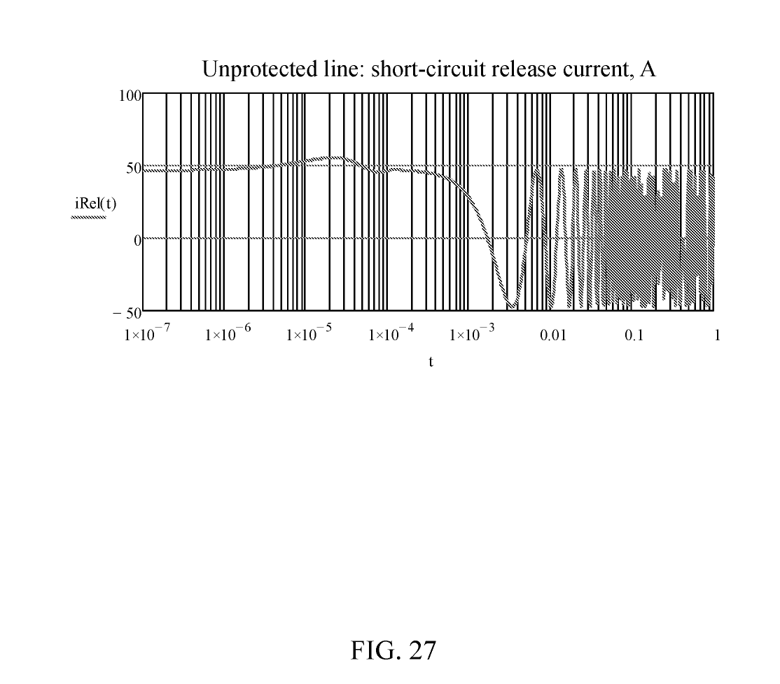

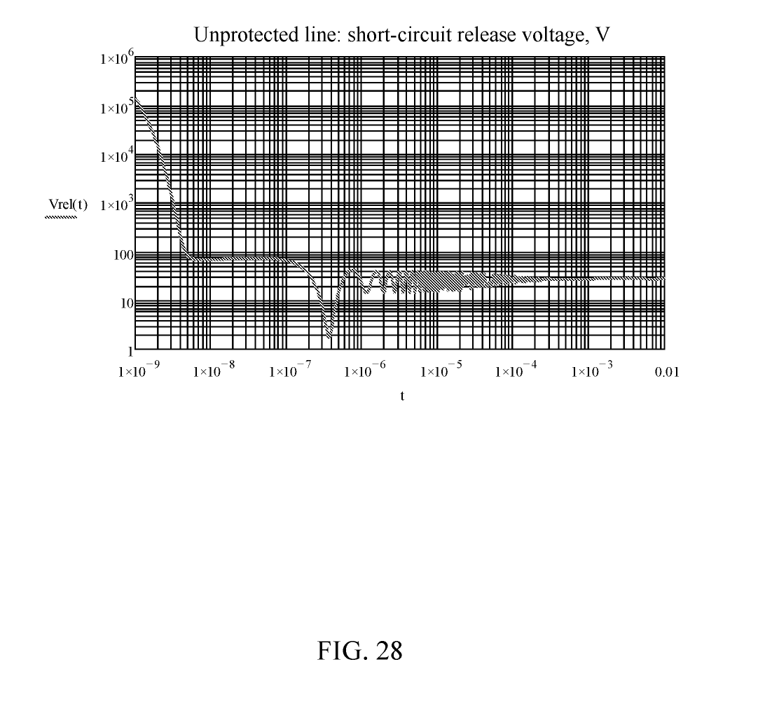

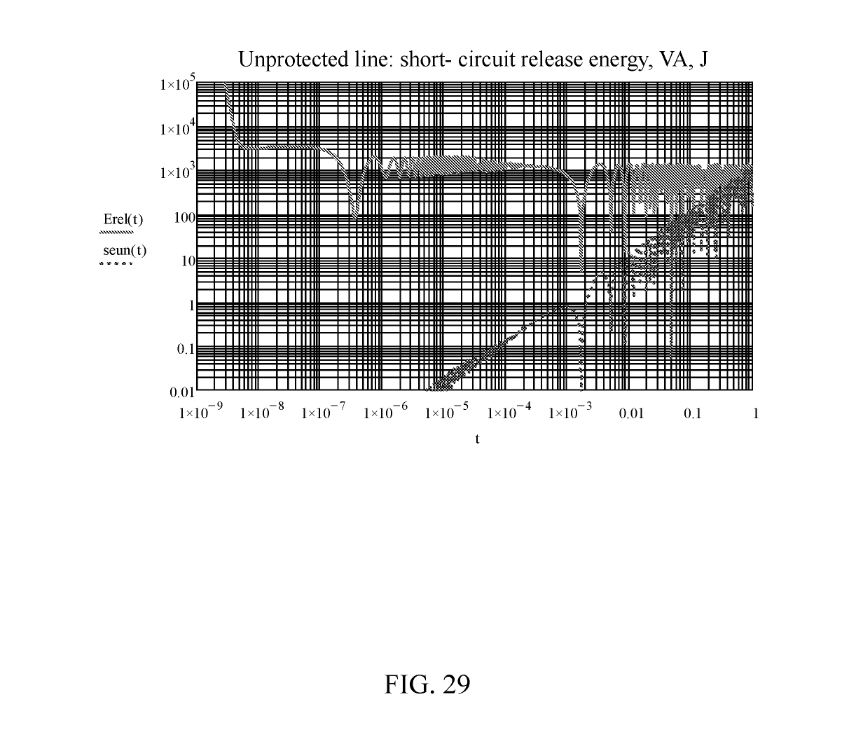

When the unprotected line with fault removal is considered the following equations are obtained and graphed in FIGS. 27-29:

$$Zrel ( s ) = 2 \cdot Rcontact + D \cdot R 1 + \frac{Rrel ( s )}{[ \begin{matrix}cosh ( D \cdot n ( s ) ) + \frac{C 1 \cdot s}{n ( s )} \cdot \\ sinh ( D \cdot n ( s ) ) \cdot \\ ( 2 \cdot Rcontact + Rrel ( s ) )\end{matrix} ]}$$

$$Irelun ( s ) = \frac{\frac{Egen}{s} + Ishort \cdot D \cdot L 1}{Rcb + 2 Rcontract + Zrel ( s )}$$

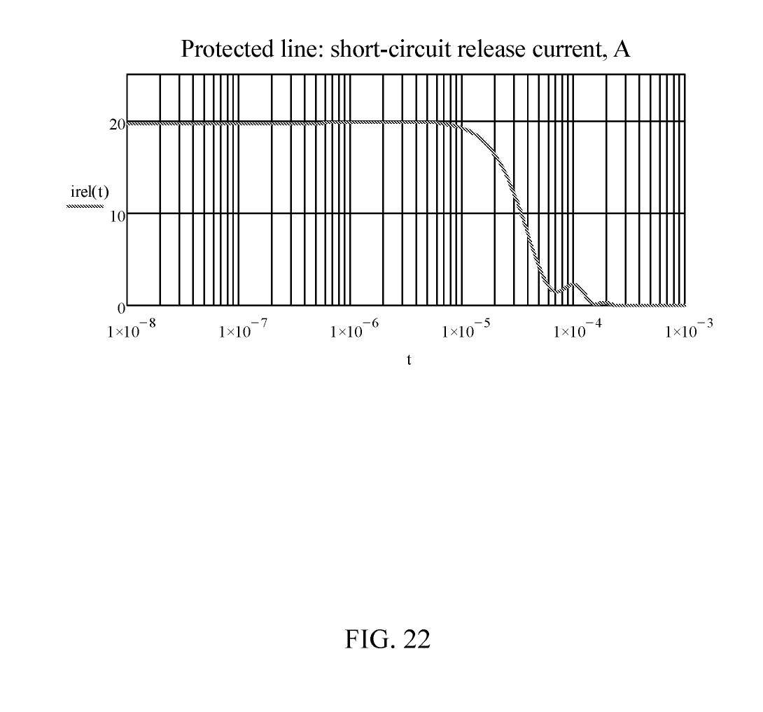

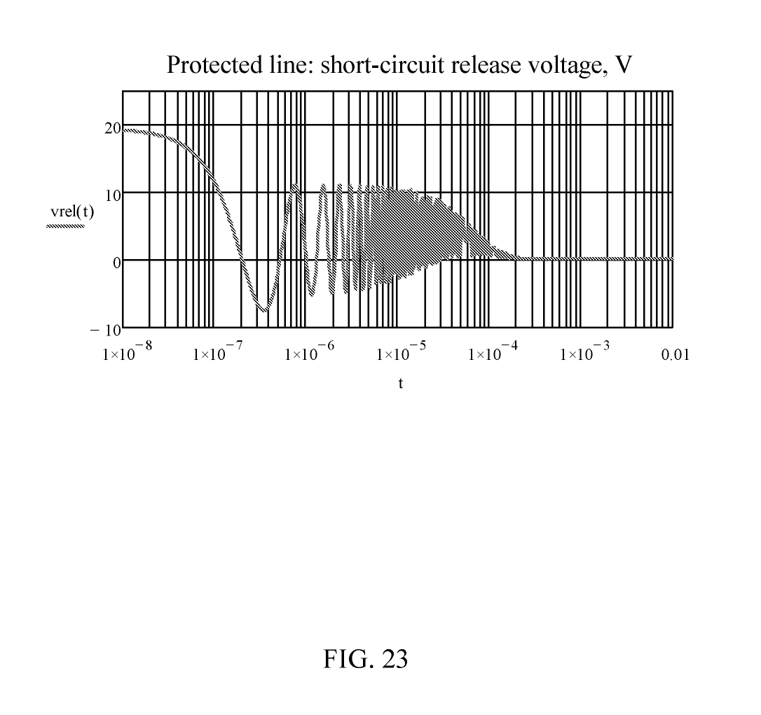

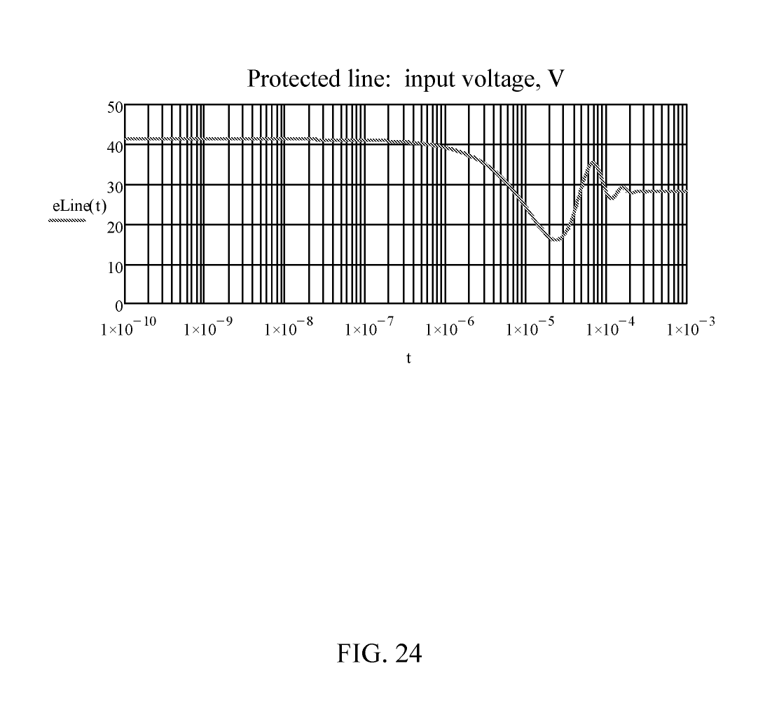

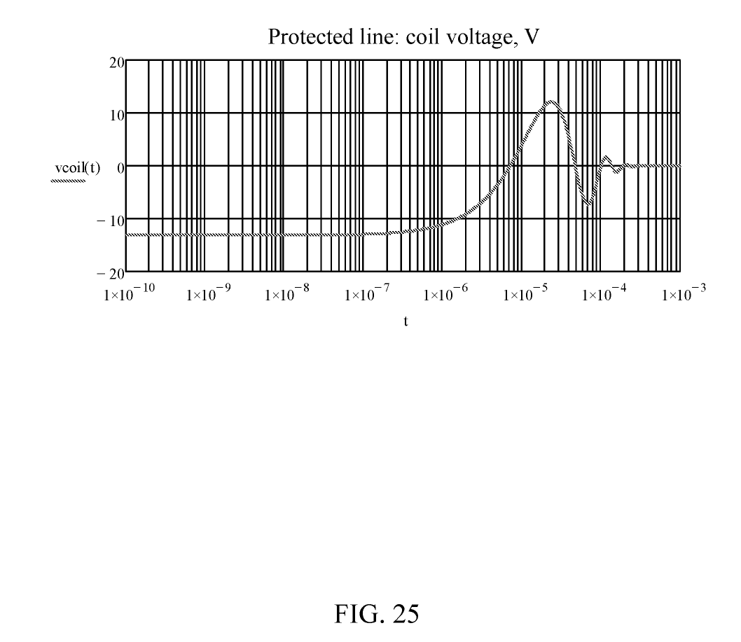

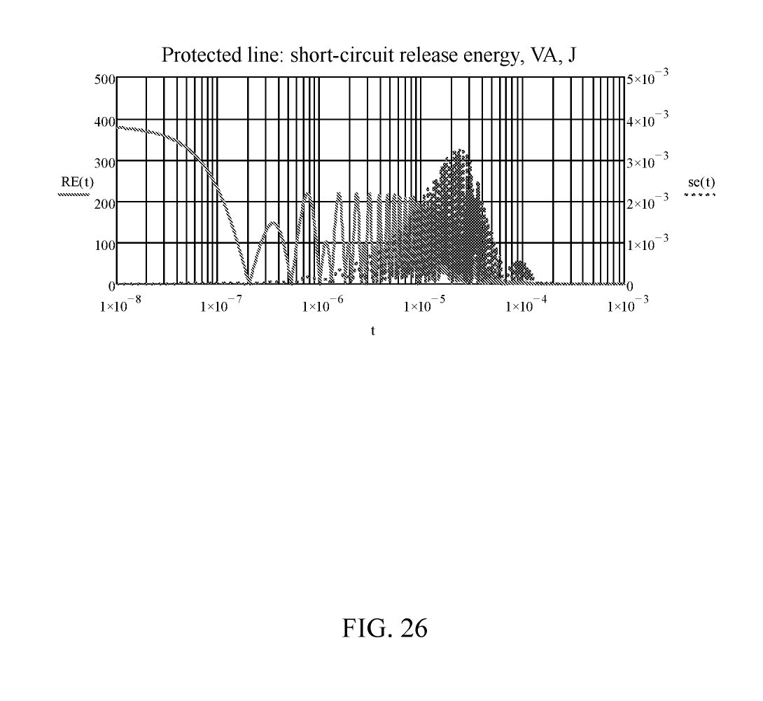

As seen in FIGS. 22-26, the power and voltage levels for the unprotected circuit are considerably large compared to the voltage and power levels of the protected circuit.
When considering a prototype of the present invention the given values were used for the following calculations. As an example, if ferrite was used for minimum weight and convenient manufacturability, the core shape of the suppressor coil is wound with 0.02 inch by 0.32 inch bare copper tape plus a layer of insulation.

### Weight=50 g

Volume=10200*10⁻⁹ m³

### Lm=52.4 mm

### Am=194 mm²

Minimum window height=11.21 mm
Minimum window length=8.62 mm
Maximum center leg=7.8 mm*25.91 mm
Maximum perimeter=67.42 mm

### Magnetic Field=3500 G

Magnetic Field strength=70 A/m

Am:=194·10⁻⁶=1.94×10⁻⁴

Lm:=52.4·10⁻³

Em:=6.36·10⁻³

### H_{core}=70 A/m

### μ=(0.35/70) H/m

μ₀=4π*10⁻⁷ H/m
μᵣ=(μ/μ₀)=3.979*10³

### B=0.35 T

N=5 turns
AT_{core}=H_{core}*L_{M}=3.668 A

AT_{coil}:=N·icoil(10⁻⁵)float,4→51.47

N·Io=50

The core air gap is calculated as follows:

$$\begin{matrix}Φ = ( Magneto Motive Force / Reluctance ) \\ = [ ( Amperage * Turns ) / Reluctance ]\end{matrix}$$

$$Core reluctance = Lm / ( μ * {A}_{m} )$$

$$Gap reluctance = gap / ( {μ}_{0} * {A}_{m} )$$

$$H = {H}_{gap} + {H}_{core}$$

$$\begin{matrix}Φ = B \cdot Am \\ = \frac{MMFcore}{Rcore} \\ = \frac{MMFgap}{Rgap} \\ = \frac{ATcore}{( \frac{Lm}{μ \cdot Am} )} \\ = \frac{ATgap}{( \frac{gap}{μ o \cdot Am} )} \\ = \frac{ATcoil - ATcore}{( \frac{gap}{μ o - Am} )}\end{matrix}$$

$$B \cdot Am = \frac{ATcoil - ATcore}{( \frac{gap}{μ o - Am} )}$$

$$gap = \frac{( ATcoil - ATcore ) \cdot μ o}{B}$$

$$Lgap = \frac{{N}^{2}}{Rcore + Rgap}$$

Core saturation increases under short circuit conditions.

$$Lsat = \frac{{N}^{2}}{Rcore \cdot \frac{Isc}{i ( {10}^{- 5} )} + Rgap}$$

Any change of the voltage across any circuit component needs to be redistributed across the other circuit impedances. The circuit current decreases due to the transferred load voltages across the circuit impedances. According to Lenz's law, the current will flow through R_{damp} initially towards the generator opposing the change in current.

$$Gap := \frac{( ATcoil - ATcore ) \cdot μ o}{B} float , 4 -> 0.0002075$$

$$Gap \cdot 39.37 \cdot in float , 4 -> 0.008169 \cdot in$$

$$gap := \frac{0.010}{39.37}$$

Max value of 0.01 (0.0095+0.0005) for the center leg grinding tolerance;

### Reluctances

$$Rcore := \frac{Lm}{μ \cdot Am} float , 2 -> 54020.0$$

$$Rgap := \frac{gap}{μ o \cdot Am} float , 3 -> 1.04 e 6$$

$${R}_{gap} / {R}_{core} = 19.252$$

$$Lgap := \frac{{N}^{2} \cdot {10}^{6} \cdot µH}{Rcore + Rgap} float , 3 -> 22.9 \cdot µH$$

### According to the Partridge Formula:

$$Ldesign := Lgap \cdot ( 1 + \frac{2 gap}{{Am}^{\frac{1}{2}}} \cdot ln ( \frac{2 \cdot Em}{gap} ) ) = 2.617 \times {10}^{- 5} H$$

$$\underline{Lsat} := \frac{{N}^{2}}{Rcore \cdot \frac{i ( 1 )}{i ( {10}^{- 5} )} + Rgap} = 2.288 \times {10}^{- 5}$$

$$Core volume = 10200 * {10}^{- 9} {m}^{3}$$

$$Estimated Core loss = 48 * {10}^{3} W \text{/} {m}^{3}$$

$$\begin{matrix}Core\_Loss := CoreVolume \cdot CoreLoss \cdot \frac{( icoil ( {10}^{- 5} ) - icoil ( 0 ) )}{2 \cdot icoil ( {10}^{- 5} )} \\ = 0.146\end{matrix}$$

$$Vp := \sqrt{\frac{{\sum }_{a = 0}^{299} {vcoil ( \frac{a}{{10}^{6}} )}^{2}}{300}} = 3.994$$

$$Core\_loss := \frac{{Vp}^{2} \cdot Ω}{Core\_Loss} = 109.167 Ω$$

The suppressor coil utilized in the example has the following properties. In the preferred embodiment of the present invention, the suppressor coil is a copper foil coil with 5 turns.
The minimum window height is 11.21 mm=0.441 inches.
Therefore, 85% of the window height=0.375 inches
Coil form perimeter=1.832 inches
Coil thickness=1.37 inches
M·T=2.288 inches
W·L=N·M·T=11.44 inches
R_{coil}=1.21*10⁻³Ω
Normal loss=0.121 W
Full short circuit loss=2.697 W
The primary capacitance is estimated as follows:

$$m * t = [ ( M * T ) / 39.3 ] m$$

$$area = 3543 * {10}^{- 4}$$

$$space = ( 0.03 ) / ( 39.37 ) m$$

$$ɛ o := 8.85 \cdot {10}^{- 12}$$

$$COIL := Kin \cdot ɛ o \cdot \frac{area}{space} \cdot \frac{1 \cdot F}{N - 1} = 2.057 \times {10}^{- 11 } F$$

Although the invention has been explained in relation to its preferred embodiment, it is to be understood that many other possible modifications and variations can be made without departing from the spirit and scope of the invention as hereinafter claimed.

What is claimed is:

1. A device for arc suppression using an alternating current power source or a direct current power source comprises:
an output source terminal;
an input load terminal;
a suppressor coil;
a shunt circuit;
the suppressor coil being electrically connected in series between the output source terminal and the input load terminal;
the shunt circuit being electrically connected in series between the output source terminal and the input load terminal; and
the suppressor coil and the shunt circuit being electrically connected in parallel to each other.

2. The device for arc suppression using an alternating current power source or a direct current power source as claimed in claim 1, wherein a fault current travels from the output source terminal to the input load terminal, and wherein the output source terminal, the suppressor coil, the input load terminal, and the shunt circuit are configured to reroute a portion of the fault current from travelling through the suppressor coil to alternatively travelling through the shunt circuit.

3. The device for arc suppression using an alternating current power source or a direct current power source as claimed in claim 2, wherein the configuration between the output source terminal, the suppressor coil, the input load terminal, and the shunt circuit manages an initial rise in current as a regular current jumps to the fault current.

4. The device for arc suppression using an alternating current power source or a direct current power source as claimed in claim 1 comprises:
an at least one power line;
the suppressor coil being electrically connected in series with the input load terminal through the power line; and
the shunt circuit being electrically connected in series with the input load terminal through the power line.

5. The device for arc suppression using an alternating current power source or a direct current power source as claimed in claim 3, wherein a portion of the power line is a portion of an aircraft body.

6. The device for arc suppression using an alternating current power source or a direct current power source as claimed in claim 1, wherein the shunt circuit comprises at least one resistor.

7. The device for arc suppression as claimed in claim 1, wherein the output source terminal is for an alternating current power source.

8. The device for arc suppression as claimed in claim 1, wherein the output source terminal is for a direct current power source.

9. The device for arc suppression using an alternating current power source or a direct current power source as claimed in claim 1 comprises:
an enclosure;
the suppressor coil and the shunt circuit being mounted within the enclosure;
the output source terminal being positioned into the enclosure; and
the input load terminal being positioned into the enclosure.

10. The device for arc suppression as claimed in claim 1, wherein the suppressor coil comprises a permeable core.

11. The device for arc suppression as claimed in claim 1, wherein the suppressor coil is an air cored coil.

12. The device for arc suppression as claimed in claim 1, wherein the suppressor coil is configured to generate electrical inductance and to be electrically resistive.
